(19) United States
(12) Patent Application Publication
(10) Pub. No.: US 2016/0378628 A1
(43) Pub. Date: Dec. 29, 2016

(54) HARDWARE PROCESSORS AND METHODS TO PERFORM SELF-MONITORING DIAGNOSTICS TO PREDICT AND DETECT FAILURE

(71) Applicant: Intel Corporation, Santa Clara, CA (US)

(72) Inventors: Hang T. Nguyen, Tempe, AZ (US); Gordon McFadden, Hillsboro, OR (US); Travis J. White, Chandler, AZ (US); Scott P. Bobholz, Bolton, MA (US); Edwin Verplanke, Chandler, AZ (US); Steven C. Franks, Folsom, CA (US); Vivek Garg, Folsom, CA (US); Ashok Raj, Portland, OR (US); Guy G. Sotomayor, San Jose, CA (US); Jose A. Vargas, Rescue, CA (US); Pradeepsunder Ganesh, Chandler, AZ (US); Stephen T. Palermo, Chandler, AZ (US)

(21) Appl. No.: 14/752,821

(22) Filed: Jun. 26, 2015

(51) Int. Cl. G06F 11/273; G06F 11/22

(52) U.S. Cl. CPC G06F 11/273; G06F 11/2236

(57) ABSTRACT

Hardware processors and methods to perform self-monitoring diagnostics to predict and detect failure are described. In one embodiment, a hardware processor includes a plurality of cores, and a diagnostic hardware unit to isolate a core of the plurality of cores at run-time, perform a stress test on an isolated core, determine a stress factor from a result of the stress test, and store the stress factor in a data storage device.

### TECHNICAL FIELD

The disclosure relates generally to electronics, and, more specifically, an embodiment of the disclosure relates to a hardware processor with a self-monitoring diagnostic hardware unit to predict and detect failure of its components.

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (I/O).

### BRIEF DESCRIPTION OF THE DRAWINGS

The present disclosure is illustrated by way of example and not limitation in the figures of the accompanying drawings, in which like references indicate similar elements and in which:

FIG. 1 illustrates a hardware processor according to embodiments of the disclosure.

FIG. 2 illustrates a flow diagram according to embodiments of the disclosure.

FIG. 3 illustrates a hardware processor according to embodiments of the disclosure.

FIG. 4 illustrates a flow diagram according to embodiments of the disclosure.

FIG. 5A is a block diagram illustrating both an exemplary in-order pipeline and an exemplary register renaming, out-of-order issue/execution pipeline according to embodiments of the disclosure.

FIG. 5B is a block diagram illustrating both an exemplary embodiment of an in-order architecture core and an exemplary register renaming, out-of-order issue/execution architecture core to be included in a processor according to embodiments of the disclosure.

FIG. 6A is a block diagram of a single processor core, along with its connection to the on-die interconnect network and with its local subset of the Level 2 (L2) cache, according to embodiments of the disclosure.

FIG. 6B is an expanded view of part of the processor core in FIG. 6A according to embodiments of the disclosure.

FIG. 7 is a block diagram of a processor that may have more than one core, may have an integrated memory controller, and may have integrated graphics according to embodiments of the disclosure.

FIG. 8 is a block diagram of a system in accordance with one embodiment of the present disclosure.

FIG. 9 is a block diagram of a more specific exemplary system in accordance with an embodiment of the present disclosure.

FIG. 10, shown is a block diagram of a second more specific exemplary system in accordance with an embodiment of the present disclosure.

FIG. 11, shown is a block diagram of a system on a chip (SoC) in accordance with an embodiment of the present disclosure.

FIG. 12 is a block diagram contrasting the use of a software instruction converter to convert binary instructions in a source instruction set to binary instructions in a target instruction set according to embodiments of the disclosure.

### DETAILED DESCRIPTION

In the following description, numerous specific details are set forth. However, it is understood that embodiments of the disclosure may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

A (e.g., hardware) processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (I/O). It should be noted that the term instruction herein may refer to a macro-instruction, e.g., an instruction that is provided to the processor for execution, or to a micro-instruction, e.g., an instruction that results from a processor's decode unit (decoder) decoding macro-instructions. A processor (e.g., having one or more cores to decode and/or execute instructions) may operate on data, for example, in performing arithmetic, logic, or other functions.

A processor may access (e.g., load and/or store) data in (e.g., separate from the processor die) a data storage device (e.g., a memory). Memory may be system memory, e.g., random access memory (RAM). A data storage device may not include a processor cache and/or not include external storage, such as, but not limited to, a hard disk drive (HDD) storage. A data storage device may be non-volatile memory, e.g., flash memory.

A processor may have a finite life, e.g., before one or more components of the processor may have a partial or total failure. A processor may have a different life span depending on its usage history, e.g., based on the total stress level it has endured. Stress level may (e.g., cumulatively) include temperature of the processor or component, operating frequency of the processor or component, power (e.g., voltage) consumption by the processor or component, for example, over a certain time period. Components of a processor may include, but are not limited to, the core of the processor, uncore of the processor, interconnection between multiple cores, decoder unit, execution unit, power management unit, interrupt management unit, error management and/or generation unit, cache or caches (e.g., and their various manifestations and levels), integrated memory controller, network controller (e.g., network interface card), integrated accelerator, or any other processor component and/or interconnection between the processor and other system components (e.g., discussed herein).

Certain embodiments of this disclosure relate to a hardware processor having a self-monitoring diagnostic hardware unit to predict and/or detect failure of its components. Certain embodiments of this disclosure provide for self-monitoring failure detection and prediction mechanisms for a hardware processor, e.g., semiconductor processor. Certain embodiments of processor failure prediction and/or detection may be extended to apply to any other integrated circuit components of a platform, e.g., including a data storage device (memory), chipset, network interface controller (NIC), etc.

Certain embodiments herein provide processor users (e.g., end users) the information to predict a system failure before the failure happens, e.g., in mission critical systems that must remain operational 24×7 such as, but not limited to, certain communication and network infrastructure deployments supporting mobile and wired networks and cloud solutions. By enabling such mission critical computing systems with error rate and component stress indicators, end users (e.g., operators) of such systems may proactively identify and respond to (e.g., potentially) faulty equipment before an issue arises (e.g., a total component failure). In one embodiment, the (e.g., potentially) faulty equipment may operate in a degraded mode (e.g., after being identified) until the equipment is upgraded (e.g., via a hardware update) or replaced (e.g., at regular maintenance cycle). Certain embodiments herein may be utilized in transportation, data center, telecommunication, high performance, industrial control, and health care computing systems, e.g., to meet resiliency and reliability requirements. Certain embodiments herein may be used in both customer computing system pre-production and post-production deployments. Certain embodiments herein may allow minimum service levels, e.g., according to a service level agreement (SLA) guaranty, to be maintained, for example, by detecting (and repairing, replacing, and/or modifying the usage) (e.g., potentially) faulty processors (e.g., processor components) before the minimum service level is not met.

In one embodiment, a hardware processor includes a diagnostic (e.g., hardware) unit to dynamically monitor (e.g., during run-time) the processor's use, for example, monitoring (e.g., logging over a time period) the operating conditions (e.g., voltage, temperature, and/or current), usage states (for example, time spent therein, e.g., in each of a device state (D0-Dn (e.g., D3)), processor state (C0-Cn (e.g., C6)), and/or performance state (P0-Pn (e.g., P16)) of the Advanced Configuration and Power Interface (ACM) specification), (e.g., correctable) error count (e.g., rates), and/or directed offline measurements of the processor's functional and performance behaviors, or any combination thereof. In one embodiment, a hardware processor includes a diagnostic (e.g., hardware) unit to provide failure prediction capability for the processor, for example, based on the processor's past and/or current use.

Certain embodiments disclosed herein provide a diagnostic hardware unit to (1) allow storage of private (e.g., encrypted) run-time processor stress test results, (2) provide a warning (e.g., as a message from an output port of the processor) of a potential processor failure (e.g., from processor stress detection), and/or (3) calibrate the potential (e.g., projected) failure warning using a failure measurement system and/or limit the failure risk(s), for example, by disabling (e.g., disallowing) a component(s) of the processor and/or generating a suggested use of processor component(s) (or the entire processor) to reduce the stress factor (e.g., by noting a usage(s) that is more likely than not to cause a fault or further exacerbate the failure condition).

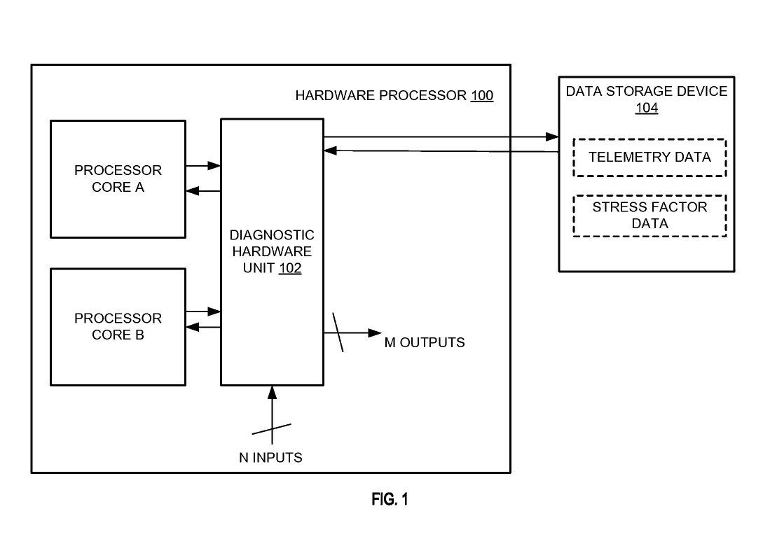

FIG. 1 illustrates a hardware processor 100 according to embodiments of the disclosure. Depicted hardware processor 100 includes processor cores A and B. Although two processor cores are depicted, one or more than two may be utilized, e.g., each with their own communication paths with a diagnostic hardware unit. Depicted hardware processor 100 includes diagnostic hardware unit 102. A diagnostic hardware unit may communicate with each processor core. A diagnostic hardware unit may take (e.g., other) inputs (e.g., N inputs in FIG. 1). A diagnostic hardware unit may provide (e.g., other) outputs (e.g., M outputs in FIG. 1). A diagnostic hardware unit may be separate from a hardware processor. A diagnostic hardware unit may be on-die with a hardware processor.

In one embodiment, diagnostic hardware unit may collect (for example, log over a time period, e.g., greater than one clock cycle) telemetry data of the processor and/or non-processor components. Telemetry data of the processor may include separate telemetry data for separate components of the processor. For example, telemetry data may include a processor's use (e.g., as discussed above). Telemetry data may be input on N (e.g., 1 or multiple) inputs and/or directly to a processor core. Sensor(s) may connect to diagnostic hardware unit 102, e.g., via N inputs. Telemetry data may include sleep states frequency, correctable error occurrences, operating voltage and temperature, operating performance information, and/or feature specific information, for example, use data for a hardware accelerator or offload unit. Telemetry data may include operating performance characteristics of a processor (e.g., CPU) and platform. Telemetry data may include use data for non-core components, for example, health statistics (e.g., eye (pattern) diagrams) of the interconnections into and/or out of the processor and/or of the other non-processor components, e.g., memory, storage and/or networking devices. Telemetry data may be gathered and stored (e.g., encrypted), for example, for (e.g., future failure estimation) analysis. In one embodiment, diagnostic hardware unit 102 may access (e.g., load and/or store) data in a data storage device 104. Data storage device may be separate from a hardware processor (e.g., as shown in FIG. 1) or on-die with a hardware processor (not depicted). Telemetry and other data communications may be wired or wireless.

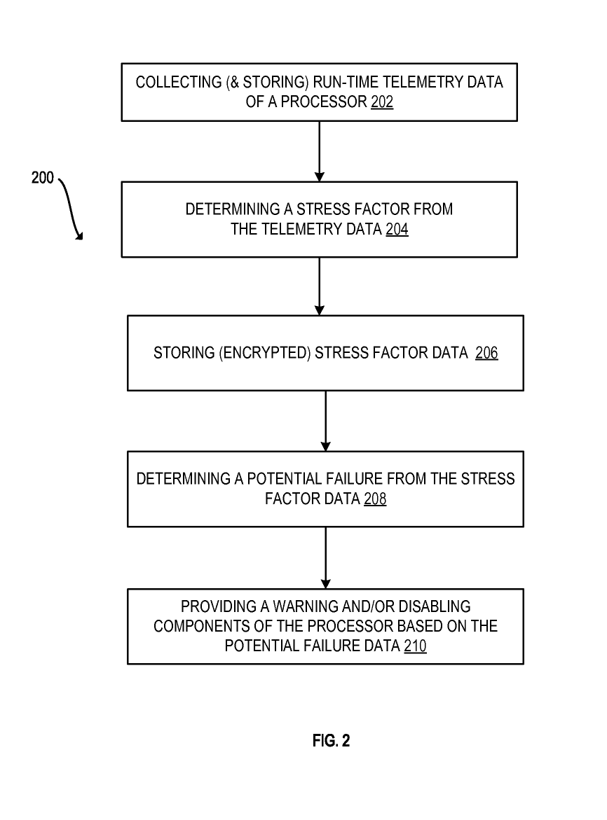

FIG. 2 illustrates a flow diagram 200 according to embodiments of the disclosure. Referring to both FIGS. 1 and 2, diagnostic hardware unit 102 may collect telemetry data and store it (e.g., with or without encryption) in data storage device 104. For example, diagnostic unit may collect (e.g., and store in a data storage device) run-time telemetry data of a processor 202. In one embodiment, the telemetry and/or other data (e.g., stress factor data) may be privately stored (e.g., with encryption) by the diagnostic hardware unit, for example, such that it is not accessible to the end user. In one embodiment, the data in a data storage device and/or diagnostic hardware unit may be locally or remotely accessible (e.g., via a wired or wireless network connection) to allow access (e.g., with or without decryption) to that stored data, for example, to the end user. In one embodiment, the user may utilize (e.g., view) the unencrypted data without bound or restriction. However, in one another embodiment, the user may only retrieve the encrypted data, e.g., but cannot utilize (e.g., inspect) this data. Encrypted data may be sent back to the processor manufacturer for analysis and results, for example, which may be shared with the user. In one embodiment, a diagnostic unit may encrypt telemetry, stress factor, potential failure, and/or failure rate data such that an end user cannot gain access to that data, e.g., except when unencrypted by an authorized party (e.g., the manufacturer). In one embodiment, a processor (e.g., in response to a user's request) may send any or all data discussed herein to the manufacturer.

Diagnostic unit may perform a stress test on a processor. The results of the stress test may be referred to as telemetry data. Processor (e.g., component or components) to be stress tested may be isolated from the processor during the test (e.g., isolated any use other than performing the stress test of its components). In one embodiment, an operating system (OS) may cause a processor component (e.g., a core) to be isolated (e.g., not used) by the OS, for example, during a stress test of that component. In one embodiment, a hardware processor may cause a processor component (e.g., a core) to be isolated (e.g., not used) from executing an operating system and/or user processes (e.g., programs), for example, during a stress test of that component. In one embodiment, an OS and/or a hardware processor may cause one or a plurality of cores to be isolated (e.g., not used) from executing an operating system and/or user processes (e.g., programs), for example, during a stress test of the one or plurality of cores. In one embodiment, an OS and/or a hardware multiple processor system may cause one or a plurality of processors to be isolated (e.g., not used) from executing an operating system and/or user processes (e.g., programs), for example, during a stress test of the one or plurality of processors. A stress test may generally refer to collecting telemetry data as a component of a processor (e.g., a core) is pushed to its maximum operating parameters (e.g., maximum load, maximum frequency, and/or maximum power applied). A stress test may push a processor to its minimum operating parameters (e.g., minimum load, minimum frequency, and/or minimum power applied). A stress test may push a component (e.g., a processor core) to (e.g., a non-permanent) failure.

In one embodiment, diagnostics may be run (e.g., simultaneously) on all the cores of a multiple core processor, for example, isolating or offlining the entire processor (e.g., system). In one embodiment, (e.g., in addition to testing a core of an on line processor), hardware and/or software may test the uncore of a processor, for example, selectively by testing the uncore portion that may be isolated, e.g., with uncore isolation hardware and/or software. In one embodiment, hardware and/or software may test an entire (e.g., computing) system after it is taken off line, for example, for diagnostic and failure prediction purposes, e.g., so there are no limitations and no hardware isolation logic required. In one embodiment, off line diagnostics and failure prediction are performed first, then the on line (e.g., with isolation) approach next.

Diagnostic hardware unit 102 may read (e.g., multiple different sets of) telemetry data from data storage device 104. For example, telemetry data may be read out of (e.g., persistent) storage at predetermined (e.g., periodic) intervals and an algorithm (e.g., with different weights for different components) may be applied to convert this telemetry data into a (e.g., single number) stress factor, e.g., to be used in predicting the potential (e.g., likelihood of) failure. In one embodiment, the potential failure is based on the level of voltage guard band consumption, the dynamic current stress level, and/or other physical telemetry parameters gathered while each component is in use. For example, a diagnostic unit may determine a stress factor from the telemetry data 204. In one embodiment, hardware and/or software may provide granular stress information according to a scale (e.g., 1-10 with 1 being the least stress and 10 being the most stress), for example, so a user may schedule critical tasks on lower stress systems (e.g., “deep green” systems) and non-critical tasks on higher stress system (e.g., “light green” or “yellow”, best effort, systems).

Diagnostic hardware unit 102 may store the stress factor data (e.g., with encryption) in data storage device 104. For example, a diagnostic unit may store (e.g., encrypted) stress factor data 206.

Diagnostic hardware unit 102 may read (e.g., multiple different sets of) stress factor data from data storage device 104. For example, stress factor data may be read out of (e.g., persistent) storage at predetermined (e.g., periodic) intervals and an algorithm (e.g., with different weights for different components) may be applied to convert this stress factor data into potential (e.g., likelihood of) failure. In one embodiment, a potential failure may be represented as number of stress hours of a component compared with a total lifespan in stress hours of the component (e.g., from an estimate or predetermined from testing). Exceeding a threshold of lifespan remaining (e.g., 1, 2, 3, 4, 5, 10, 15%) may indicate the component has a (e.g., high) potential failure. In one embodiment, a rate of accumulation of stress hours of a component may be compared to an average rate of accumulation of stress hours of the component (e.g., from an estimate or predetermined from testing). A rate exceeding the average rate may indicate the component has a (e.g., high) potential failure. For example, a diagnostic unit may determine a potential failure from the stress factor data 208. Diagnostic unit may determine a potential failure from the stress factor data with its own resources (e.g., not utilizing the resources of the component in question). In one embodiment, to allow run-time potential failure (e.g., failure rate) analysis to proceed without adversely effecting performance, the determination of the potential failure (e.g., system operation failure rate analysis) may be performed on a separate component (e.g., processor core) with only its own resources and/or isolated from the run-time environment.

Once a potential failure is determined (e.g., a level of potential failure exceeding a threshold), diagnostic hardware unit 102 may take one or more actions, for example, causing one or more outputs from the M outputs thereof, causing that component (e.g., core) to be isolated, causing that component (e.g., core) to be electrically swapped with another (e.g., spare) core, causing a warning to be generated (for example, to an end user, e.g., to a display screen) and may include a description of the potential failure, causing a suggested use of components of the core (e.g., to reduce the stress factor) to be generated (for example, to an end user, e.g., to a display screen), disabling at least one component (e.g., the core), for example, to reduce the stress factor, or any combinations thereof. For example, a diagnostic unit may provide a warning and/or disable components of the processor based on the potential failure 210. In one embodiment, once the potential failure (e.g., failure rate analysis) determination is complete, the output conclusion may be stored (e.g., and encrypted for restricted access retrieval). A warning may also be provided to a user (e.g., end user) to take appropriate action(s) based on the severity level. After the user (e.g., end user) is warned of a potential failure, the diagnostic unit may send the failure information off (e.g., to the user) to use any of the above results (e.g., with other information from manual measurements), for example to recommend use(s) to reduce further stress of the processor.

A processor that is to utilize a diagnostic hardware unit may include an instruction (e.g., with a particular opcode) in its instruction set that causes the diagnostic hardware unit to perform operation(s) disclosed herein, e.g., when the instruction is executed. In one embodiment, a diagnostic hardware unit includes a finite state machine (FSM) to control its operations, e.g., as discussed herein. In one embodiment, a hardware diagnostic unit performs operation(s) disclosed herein when the hardware processor is powered on, e.g., without execution of an instruction.

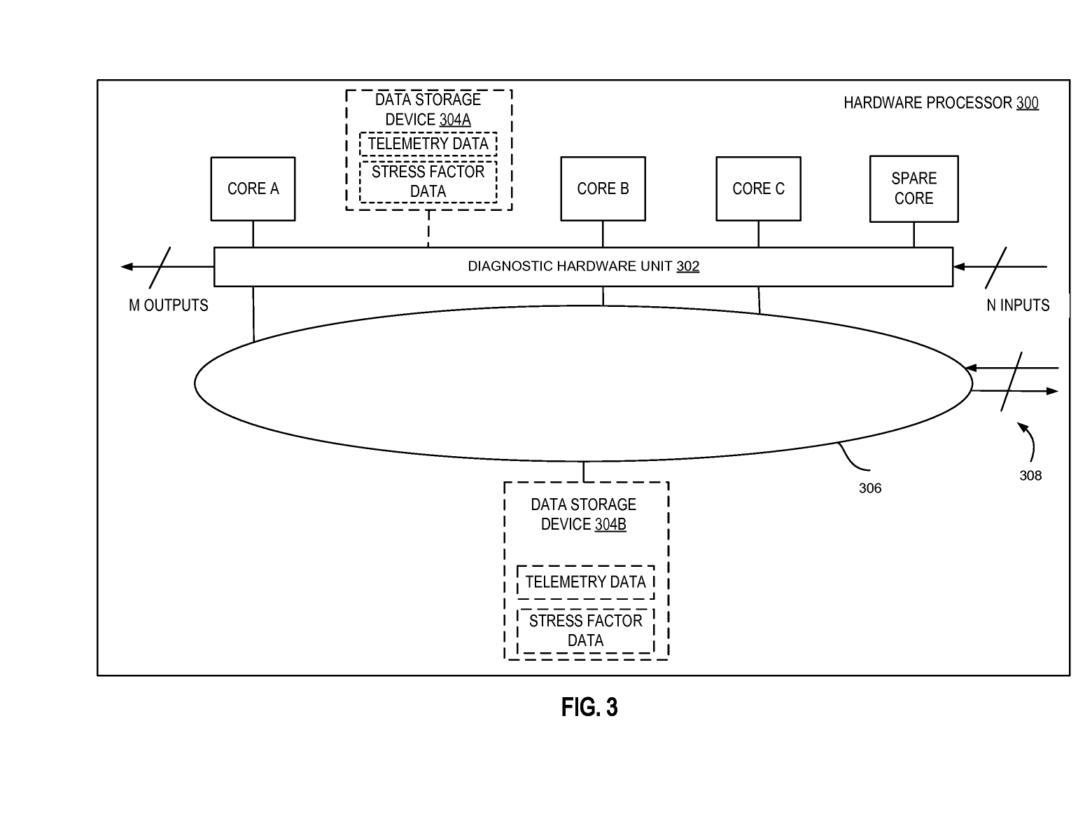

FIG. 3 illustrates a hardware processor 300 according to embodiments of the disclosure. As discussed above, certain embodiments of this disclosure may include isolating a processor core, for example, to perform a stress test on that isolated core, e.g., without affecting the other components (e.g., cores) of the processor. In one embodiment, the isolated (e.g., swapped out) core may be pushed until (e.g., non-permanent) failure and the telemetry data collected for that process.

Depicted hardware processor 300 includes cores A, B, C, and spare core. Any one or plurality of cores and a spare core may be utilized. Spare core may be of the same type (e.g., homogeneous) with the other cores. Spare core may be used to process (e.g., non-diagnostic) instructions when not being used as a spare core. Hardware processor may include a communication network between components of the processor. Depicted hardware processor 300 includes a ring network between the processor cores. Other components, e.g., memory, graphics processing unit, etc., may also communicate on the ring network, e.g., shown schematically at inputs and outputs 308. Diagnostic hardware unit 302 may operate according to any of the disclosure herein. Diagnostic hardware unit 302 includes M outputs and N inputs (e.g., see the discussion in reference to FIG. 1). Hardware processor may include access to a data storage device, shown optionally and schematically as data storage device 304A and data storage device 304B. In one embodiment, either or both of data storage device 304A and data storage device 304B may be utilized. A data storage device may be on-die or a separate component from a hardware processor. Diagnostic hardware unit 302 may communicate directly with data storage device 304A. Diagnostic hardware unit 302 may communicate via communication network (e.g., ring network 306) with data storage device 304B.

In one embodiment, diagnostic hardware unit may collect (for example, by logging over a time period, e.g., greater than one clock cycle) telemetry data of the processor and/or non-processor components. Telemetry data of the processor may include separate telemetry data for each of separate components of the processor. For example, telemetry data may include a processor's performance in a stress test (e.g., as discussed above). Telemetry data may be input on N (e.g., 1 or a multiple) inputs and/or directly from a processor core to the diagnostic hardware unit 302. In one embodiment, diagnostic hardware unit 302 may receive telemetry data for a component (e.g., cores A, B, and/or C) by monitoring the data between each core and the ring network.

In one embodiment, diagnostic hardware unit 302 may electrically (e.g., logically and electrically, as opposed to physically) swap the spare core for one of the other cores (e.g., cores A, B, and/or C). Diagnostic hardware unit 302 may include a circuit (e.g., switches) to electrically swap the spare core for one of the other cores (e.g., cores A, B, and/or C). For example, the diagnostic hardware core may electrically swap core A for the spare core, e.g., to perform a stress test on the isolated core A and/or to remove a (e.g., potentially) failing core A from use by the hardware processor. Spare core in such an embodiment may then take the load (e.g., the instructions that were scheduled to be executed) for the swapped out core. When the stress test is complete, the spare core may be returned to its spare state (e.g., not being used or otherwise idle). In one embodiment, the ring network connection for the core to be isolated, e.g., core A in the above example, may be switched from core A to the spare core. The isolated core, e.g., core A, may then be connected to (e.g., a test port of) diagnostic hardware unit 302.

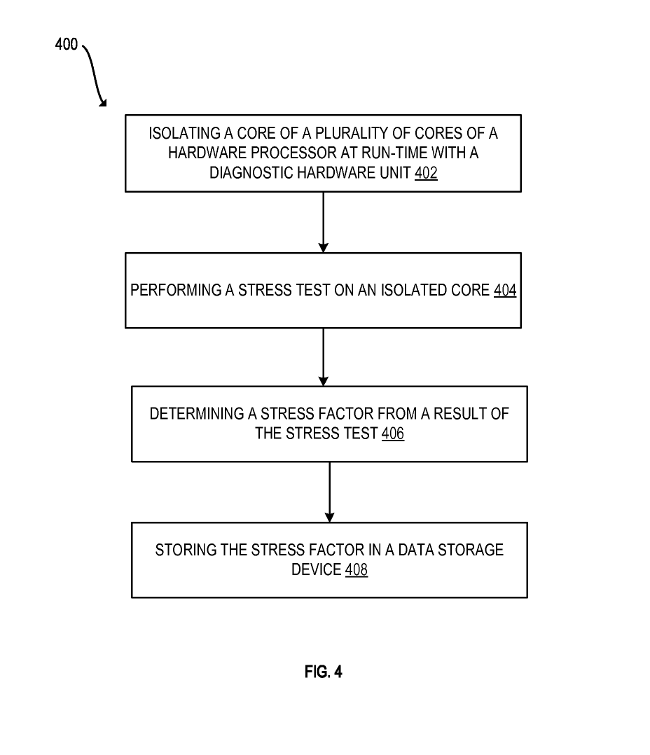

Although a single spare core is shown, a plurality may be used, e.g., for each spare core to replace multiple of the other non-spare cores (e.g., cores A, B, and/or C). Spare core may be referred to as “core D” in FIG. 4, e.g., not necessarily only for use as a spare.

FIG. 4 illustrates a flow diagram 400 according to embodiments of the disclosure. Depicted flow includes isolating a core of a plurality of cores of a hardware processor at run-time with a diagnostic hardware unit 402, performing a stress test on an isolated core 404, determining a stress factor from a result of the stress test 406, and storing the stress factor in a data storage device 408.

In one embodiment, a hardware processor includes a plurality of cores, and a diagnostic hardware unit to isolate a core of the plurality of cores at run-time, perform a stress test on an isolated core, determine a stress factor from a result of the stress test, and store the stress factor in a data storage device. The result of the stress test may be run-time telemetry data of the core over multiple processor cycles. The diagnostic hardware unit may collect the run-time telemetry data and encrypt the run-time telemetry data before storing in the data storage device. The diagnostic hardware unit may electrically (e.g., electrically and logically) swap a spare core of the plurality of cores with the isolated core. The diagnostic hardware unit may encrypt the stress factor before storing in the data storage device. The diagnostic hardware unit may generate a warning of a potential failure of the core, processor, and/or other system based on the stress factor. The diagnostic hardware unit may generate a suggested use of components of the core, processor, and/or other system to reduce the stress factor. The diagnostic hardware unit may disable at least one component of the core, processor, and/or other system to reduce the stress factor.

In another embodiment, a method includes isolating a core of a plurality of cores of a hardware processor at run-time with a diagnostic hardware unit, performing a stress test on an isolated core, determining a stress factor from a result of the stress test, and storing the stress factor in a data storage device. The result of the stress test may be run-time telemetry data of the core (e.g., collected) over multiple processor cycles. The method may include collecting the run-time telemetry data and/or encrypting the run-time telemetry data before storing in the data storage device. The isolating may include electrically (e.g., electrically and logically) swapping a spare core of the plurality of cores with the isolated core. The method may further include encrypting the stress factor before the storing in the data storage device. The method may further include generating a warning of a potential failure of the core, processor, and/or other system based on the stress factor. The method may further include generating a suggested use of components of the core, processor, and/or other system to reduce the stress factor. The method may further include disabling at least one component of the core, processor, and/or other system to reduce the stress factor.

In yet another embodiment, a non-transitory machine readable storage medium having stored program code that when processed by a machine causes a method to be performed, the method includes isolating a core of a plurality of cores of a hardware processor at run-time with a diagnostic hardware unit, performing a stress test on an isolated core, determining a stress factor from a result of the stress test, and storing the stress factor in a data storage device. The result of the stress test may be run-time telemetry data of the core (e.g., collected) over multiple processor cycles. The method may include collecting the run-time telemetry data and/or encrypting the run-time telemetry data before storing in the data storage device. The isolating may include electrically (e.g., electrically and logically) swapping a spare core of the plurality of cores with the isolated core. The method may further include encrypting the stress factor before the storing in the data storage device. The method may further include generating a warning of a potential failure of the core, processor, and/or other system based on the stress factor. The method may further include generating a suggested use of components of the core, processor, and/or other system to reduce the stress factor. The method may further include disabling at least one component of the core, processor, and/or other system to reduce the stress factor.

In another embodiment, a hardware apparatus includes a hardware processor with a plurality of cores, a data storage device, and a diagnostic hardware unit to isolate a core of the plurality of cores at run-time, perform a stress test on an isolated core, determine a stress factor from a result of the stress test, and store the stress factor in the data storage device. The result of the stress test may be run-time telemetry data of the core over multiple processor cycles. The diagnostic hardware unit may collect the run-time telemetry data and encrypt the run-time telemetry data before storing in the data storage device. The diagnostic hardware unit may electrically (e.g., electrically and logically) swap a spare core of the plurality of cores with the isolated core. The diagnostic hardware unit may encrypt the stress factor before storing in the data storage device. The diagnostic hardware unit may generate a warning of a potential failure of the core, processor, and/or other system based on the stress factor. The diagnostic hardware unit may generate a suggested use of components of the core, processor, and/or other system to reduce the stress factor. The diagnostic hardware unit may disable at least one component of the core, processor, and/or other system to reduce the stress factor.

In yet another embodiment, a hardware processor includes a plurality of cores, and means to isolate a core of the plurality of cores at run-time (e.g., the cores that are still running in non-isolated (e.g., normal) mode), perform a stress test on an isolated core, determine a stress factor from a result of the stress test, and store the stress factor in a data storage device.

In another embodiment, an apparatus comprises a data storage device that stores code that when executed by a hardware processor causes the hardware processor to perform any method disclosed herein.

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, April 2015; and see Intel® Architecture Instruction Set Extensions Programming Reference, October 2014).

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

In-order and out-of-order core block diagram

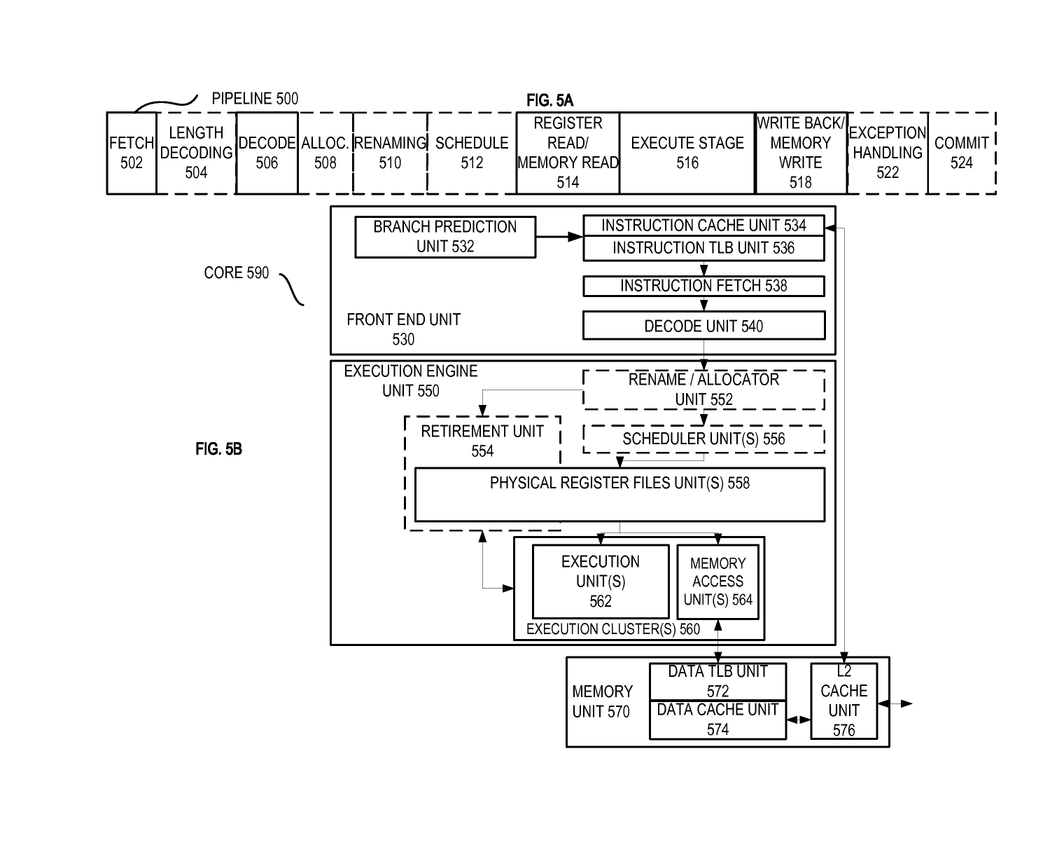

FIG. 5A is a block diagram illustrating both an exemplary in-order pipeline and an exemplary register renaming, out-of-order issue/execution pipeline according to embodiments of the disclosure. FIG. 5B is a block diagram illustrating both an exemplary embodiment of an in-order architecture core and an exemplary register renaming, out-of-order issue/execution architecture core to be included in a processor according to embodiments of the disclosure. The solid lined boxes in FIGS. 5A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 5A, a processor pipeline 500 includes a fetch stage 502, a length decode stage 504, a decode stage 506, an allocation stage 508, a renaming stage 510, a scheduling (also known as a dispatch or issue) stage 512, a register read/memory read stage 514, an execute stage 516, a write back/memory write stage 518, an exception handling stage 522, and a commit stage 524.

FIG. 5B shows processor core 590 including a front end unit 530 coupled to an execution engine unit 550, and both are coupled to a memory unit 570. The core 590 may be a reduced instruction set computing (RISC) core, a complex instruction set computing (CISC) core, a very long instruction word (VLIW) core, or a hybrid or alternative core type. As yet another option, the core 590 may be a special-purpose core, such as, for example, a network or communication core, compression engine, coprocessor core, general purpose computing graphics processing unit (GPGPU) core, graphics core, or the like.

The front end unit 530 includes a branch prediction unit 532 coupled to an instruction cache unit 534, which is coupled to an instruction translation lookaside buffer (TLB) 536, which is coupled to an instruction fetch unit 538, which is coupled to a decode unit 540. The decode unit 540 (or decoder or decoder unit) may decode instructions (e.g., macro-instructions), and generate as an output one or more micro-operations, micro-code entry points, micro-instructions, other instructions, or other control signals, which are decoded from, or which otherwise reflect, or are derived from, the original instructions. The decode unit 540 may be implemented using various different mechanisms. Examples of suitable mechanisms include, but are not limited to, look-up tables, hardware implementations, programmable logic arrays (PLAs), microcode read only memories (ROMs), etc. In one embodiment, the core 590 includes a microcode ROM or other medium that stores microcode for certain macroinstructions (e.g., in decode unit 540 or otherwise within the front end unit 530). The decode unit 540 is coupled to a rename/allocator unit 552 in the execution engine unit 550.

The execution engine unit 550 includes the rename/allocator unit 552 coupled to a retirement unit 554 and a set of one or more scheduler unit(s) 556. The scheduler unit(s) 556 represents any number of different schedulers, including reservations stations, central instruction window, etc. The scheduler unit(s) 556 is coupled to the physical register file(s) unit(s) 558. Each of the physical register file(s) units 558 represents one or more physical register files, different ones of which store one or more different data types, such as scalar integer, scalar floating point, packed integer, packed floating point, vector integer, vector floating point-status (e.g., an instruction pointer that is the address of the next instruction to be executed), etc. In one embodiment, the physical register file(s) unit 558 comprises a vector registers unit, a write mask registers unit, and a scalar registers unit. These register units may provide architectural vector registers, vector mask registers, and general purpose registers. The physical register file(s) unit(s) 558 is overlapped by the retirement unit 554 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 554 and the physical register file(s) unit(s) 558 are coupled to the execution cluster(s) 560. The execution cluster(s) 560 includes a set of one or more execution units 562 and a set of one or more memory access units 564. The execution units 562 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 556, physical register file(s) unit(s) 558, and execution cluster(s) 560 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 564). It should also be understood that where separate pipelines are used, one or more of these pipelines may be out-of-order issue/execution and the rest in-order.

The set of memory access units 564 is coupled to the memory unit 570, which includes a data TLB unit 572 coupled to a data cache unit 574 coupled to a level 2 (L2) cache unit 576. In one exemplary embodiment, the memory access units 564 may include a load unit, a store address unit, and a store data unit, each of which is coupled to the data TLB unit 572 in the memory unit 570. The instruction cache unit 534 is further coupled to a level 2 (L2) cache unit 576 in the memory unit 570. The L2 cache unit 576 is coupled to one or more other levels of cache and eventually to a main memory.

By way of example, the exemplary register renaming, out-of-order issue/execution core architecture may implement the pipeline 500 as follows: 1) the instruction fetch 538 performs the fetch and length decoding stages 502 and 504; 2) the decode unit 540 performs the decode stage 506; 3) the rename/allocator unit 552 performs the allocation stage 508 and renaming stage 510; 4) the scheduler unit(s) 556 performs the schedule stage 512; 5) the physical register file(s) unit(s) 558 and the memory unit 570 perform the register read/memory read stage 514; the execution cluster 560 perform the execute stage 516; 6) the memory unit 570 and the physical register file(s) unit(s) 558 perform the write back/memory write stage 518; 7) various units may be involved in the exception handling stage 522; and 8) the retirement unit 554 and the physical register file(s) unit(s) 558 perform the commit stage 524.

The core 590 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 590 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 534/574 and a shared L2 cache unit 576, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

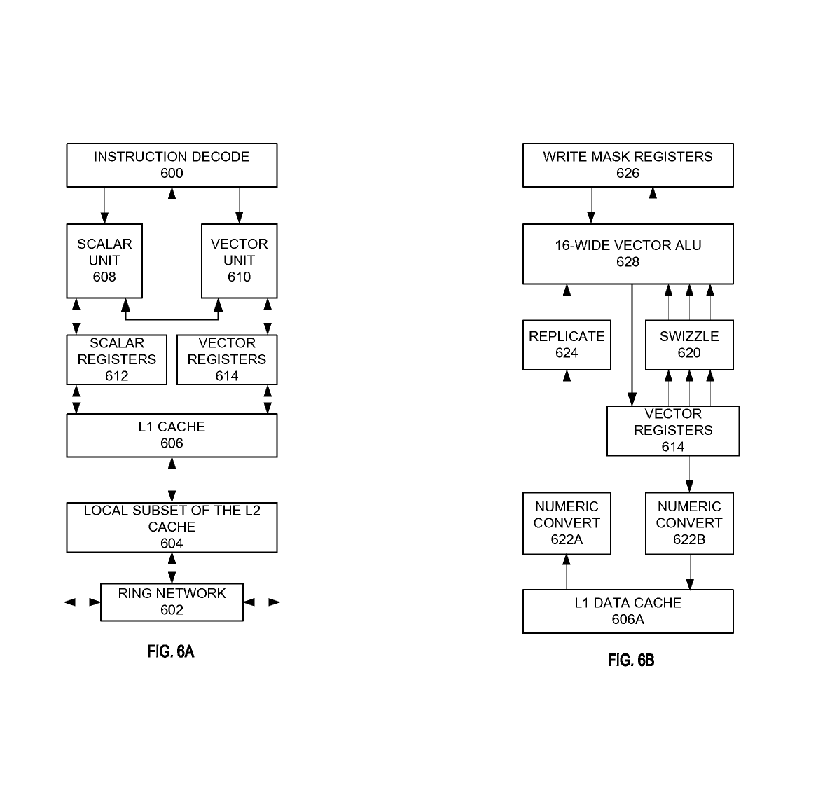

FIGS. 6A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 6A is a block diagram of a single processor core, along with its connection to the on-die interconnect network 602 and with its local subset of the Level 2 (L2) cache 604, according to embodiments of the disclosure. In one embodiment, an instruction decode unit 600 supports the x86 instruction set with a packed data instruction set extension. An L1 cache 606 allows low-latency accesses to cache memory into the scalar and vector units. While in one embodiment (to simplify the design), a scalar unit 608 and a vector unit 610 use separate register sets (respectively, scalar registers 612 and vector registers 614) and data transferred between them is written to memory and then read back in from a level 1 (L1) cache 606, alternative embodiments of the disclosure may use a different approach (e.g., use a single register set or include a communication path that allow data to be transferred between the two register files without being written and read back).

The local subset of the L2 cache 604 is part of a global L2 cache that is divided into separate local subsets, one per processor core. Each processor core has a direct access path to its own local subset of the L2 cache 604. Data read by a processor core is stored in its L2 cache subset 604 and can be accessed quickly, in parallel with other processor cores accessing their own local L2 cache subsets. Data written by a processor core is stored in its own L2 cache subset 604 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 6B is an expanded view of part of the processor core in FIG. 6A according to embodiments of the disclosure. FIG. 6B includes an L1 data cache 606A part of the L1 cache 604, as well as more detail regarding the vector unit 610 and the vector registers 614. Specifically, the vector unit 610 is a 16-wide vector processing unit (VPU) (see the 16-wide ALU 628), which executes one or more of integer, single-precision float, and double-precision float instructions. The VPU supports swizzling the register inputs with swizzle unit 620, numeric conversion with numeric convert units 622A-B, and replication with replication unit 624 on the memory input. Write mask registers 626 allow predicating resulting vector writes.

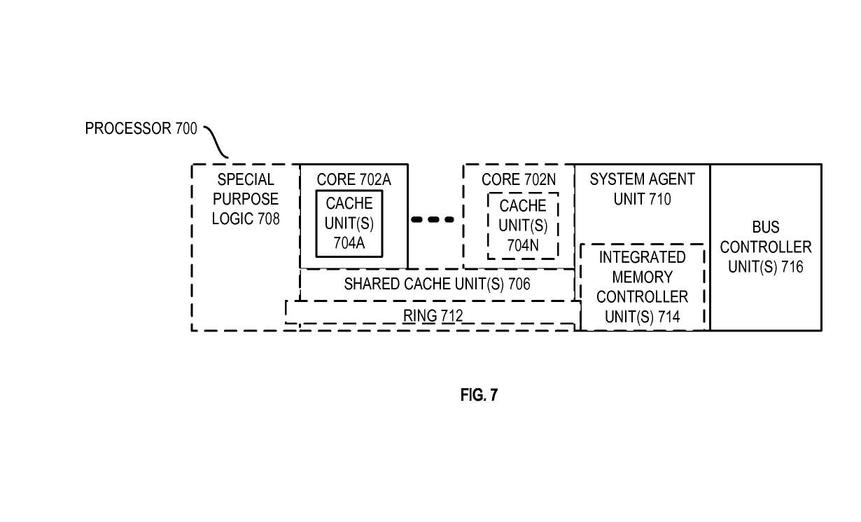

FIG. 7 is a block diagram of a processor 700 that may have more than one core, may have an integrated memory controller, and may have integrated graphics according to embodiments of the disclosure. The solid lined boxes in FIG. 7 illustrate a processor 700 with a single core 702A, a system agent 710, a set of one or more bus controller units 716, while the optional addition of the dashed lined boxes illustrates an alternative processor 700 with multiple cores 702A-N, a set of one or more integrated memory controller unit(s) 714 in the system agent unit 710, and special purpose logic 708.

Thus, different implementations of the processor 700 may include: 1) a CPU with the special purpose logic 708 being integrated graphics and/or scientific (throughput) logic (which may include one or more cores), and the cores 702A-N being one or more general purpose cores (e.g., general purpose in-order cores, general purpose out-of-order cores, a combination of the two); 2) a coprocessor with the cores 702A-N being a large number of special purpose cores intended primarily for graphics and/or scientific (throughput); and 3) a coprocessor with the cores 702A-N being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 706, and external memory (not shown) coupled to the set of integrated memory controller units 714. The set of shared cache units 706 may include one or more mid-level caches, such as level 2 (L2), level 3 (L3), level 4 (L4), or other levels of cache, a last level cache (LLC), and/or combinations thereof. While in one embodiment a ring based interconnect unit 712 interconnects the integrated graphics logic 708, the set of shared cache units 706, and the system agent unit 710/integrated memory controller unit(s) 714, alternative embodiments may use any number of well-known techniques for interconnecting such units. In one embodiment, coherency is maintained between one or more cache units 706 and cores 702-A-N.

In some embodiments, one or more of the cores 702A-N are capable of multi-threading. The system agent 710 includes those components coordinating and operating cores 702A-N. The system agent unit 710 may include for example a power control unit (PCU) and a display unit. The PCU may be or include logic and components needed for regulating the power state of the cores 702A-N and the integrated graphics logic 708. The display unit is for driving one or more externally connected displays.

The cores 702A-N may be homogenous or heterogeneous in terms of architecture instruction set; that is, two or more of the cores 702A-N may be capable of execution the same instruction set, while others may be capable of executing only a subset of that instruction set or a different instruction set.

### Exemplary Computer Architectures

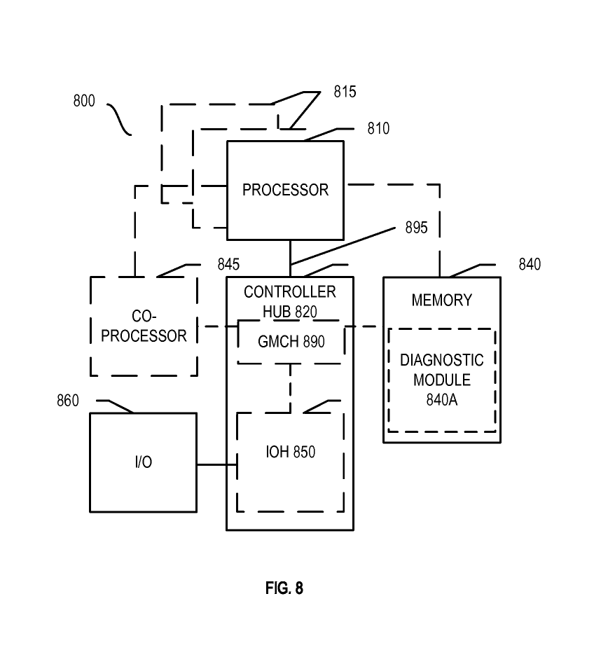

FIGS. 8-11 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 8, shown is a block diagram of a system 800 in accordance with one embodiment of the present disclosure. The system 800 may include one or more processors 810, 815, which are coupled to a controller hub 820. In one embodiment the controller hub 820 includes a graphics memory controller hub (GMCH) 890 and an Input/Output Hub (IOH) 850 (which may be on separate chips); the GMCH 890 includes memory and graphics controllers to which are coupled memory 840 and a coprocessor 845; the IOH 850 is couples input/output (I/O) devices 860 to the GMCH 890. Alternatively, one or both of the memory and graphics controllers are integrated within the processor (as described herein), the memory 840 and the coprocessor 845 are coupled directly to the processor 810, and the controller hub 820 in a single chip with the IOH 850. Memory 840 may include a diagnostic module 840A, for example, to store code that when executed causes a processor to perform any method of this disclosure.

The optional nature of additional processors 815 is denoted in FIG. 8 with broken lines. Each processor 810, 815 may include one or more of the processing cores described herein and may be some version of the processor 700.

The memory 840 may be, for example, dynamic random access memory (DRAM), phase change memory (PCM), or a combination of the two. For at least one embodiment, the controller hub 820 communicates with the processor(s) 810, 815 via a multi-drop bus, such as a frontside bus (FSB), point-to-point interface such as QuickPath Interconnect (QPI), or similar connection 895.

In one embodiment, the coprocessor 845 is a special-purpose processor, such as, for example, a high-throughput MIC processor, a network or communication processor, compression engine, graphics processor, GPGPU, embedded processor, or the like. In one embodiment, controller hub 820 may include an integrated graphics accelerator.

There can be a variety of differences between the physical resources 810, 815 in terms of a spectrum of metrics of merit including architectural, microarchitectural, thermal, power consumption characteristics, and the like.

In one embodiment, the processor 810 executes instructions that control data processing operations of a general type. Embedded within the instructions may be coprocessor instructions. The processor 810 recognizes these coprocessor instructions as being of a type that should be executed by the attached coprocessor 845. Accordingly, the processor 810 issues these coprocessor instructions (or control signals representing coprocessor instructions) on a coprocessor bus or other interconnect, to coprocessor 845. Coprocessor(s) 845 accept and execute the received coprocessor instructions.

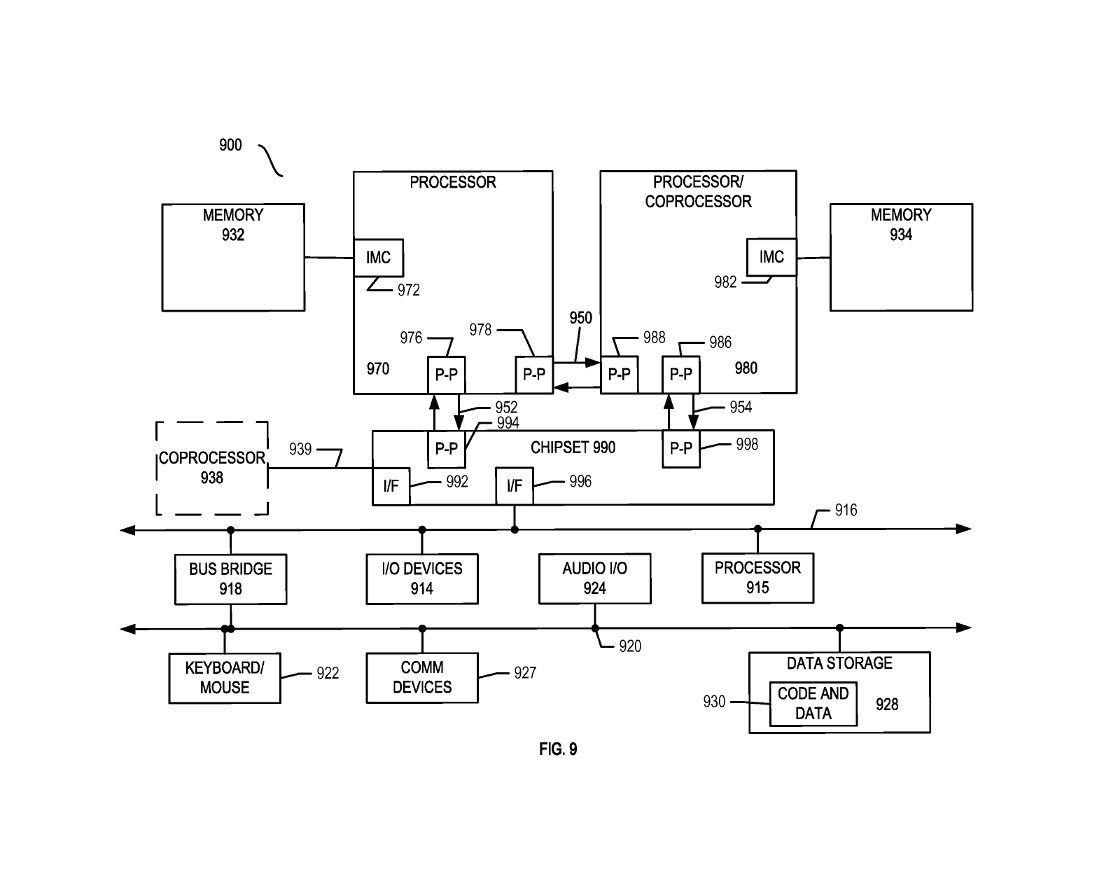

Referring now to FIG. 9, shown is a block diagram of a first more specific exemplary system 900 in accordance with an embodiment of the present disclosure. As shown in FIG. 9, multiprocessor system 900 is a point-to-point interconnect system, and includes a first processor 970 and a second processor 980 coupled via a point-to-point interconnect 950. Each of processors 970 and 980 may be some version of the processor 700. In one embodiment of the disclosure, processors 970 and 980 are respectively processors 810 and 815, while coprocessor 938 is coprocessor 845. In another embodiment, processors 970 and 980 are respectively processor 810 coprocessor 845.

Processors 970 and 980 are shown including integrated memory controller (IMC) units 972 and 982, respectively. Processor 970 also includes as part of its bus controller units point-to-point (P-P) interfaces 976 and 978; similarly, second processor 980 includes P-P interfaces 986 and 988. Processors 970, 980 may exchange information via a point-to-point (P-P) interface 950 using P-P interface circuits 978, 988. As shown in FIG. 9, IMCs 972 and 982 couple the processors to respective memories, namely a memory 932 and a memory 934, which may be portions of main memory locally attached to the respective processors.

Processors 970, 980 may each exchange information with a chipset 990 via individual P-P interfaces 952, 954 using point to point interface circuits 976, 994, 986, 998. Chipset 990 may optionally exchange information with the coprocessor 938 via a high-performance interface 939. In one embodiment, the coprocessor 938 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 990 may be coupled to a first bus 916 via an interface 996. In one embodiment, first bus 916 may be a Peripheral Component Interconnect (PCI) bus, or a bus such as a PCI Express bus or another third generation I/O interconnect bus, although the scope of the present disclosure is not so limited.

As shown in FIG. 9, various I/O devices 914 may be coupled to first bus 916, along with a bus bridge 918 which couples first bus 916 to a second bus 920. In one embodiment, one or more additional processor(s) 915, such as coprocessors, high-throughput MIC processors, GPGPU's, accelerators (such as, e.g., graphics accelerators or digital signal processing (DSP) units), field programmable gate arrays, or any other processor, are coupled to first bus 916. In one embodiment, second bus 920 may be a low pin count (LPC) bus. Various devices may be coupled to a second bus 920 including, for example, a keyboard and/or mouse 922, communication devices 927 and a storage unit 928 such as a disk drive or other mass storage device which may include instructions/code and data 930, in one embodiment. Further, an audio I/O 924 may be coupled to the second bus 920. Note that other architectures are possible. For example, instead of the point-to-point architecture of FIG. 9, a system may implement a multi-drop bus or other such architecture.

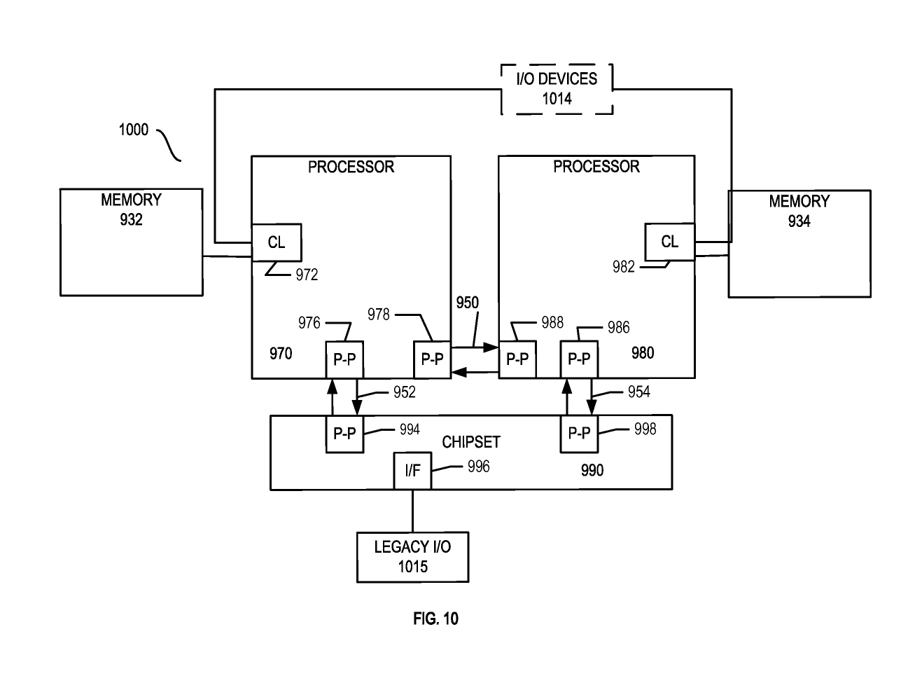

Referring now to FIG. 10, shown is a block diagram of a second more specific exemplary system 1000 in accordance with an embodiment of the present disclosure. Like elements in FIGS. 9 and 10 bear like reference numerals, and certain aspects of FIG. 9 have been omitted from FIG. 10 in order to avoid obscuring other aspects of FIG. 10.

FIG. 10 illustrates that the processors 970, 980 may include integrated memory and I/O control logic (“CL”) 972 and 982, respectively. Thus, the CL 972, 982 include integrated memory controller units and include I/O control logic. FIG. 10 illustrates that not only are the memories 932, 934 coupled to the CL 972, 982, but also that I/O devices 1014 are also coupled to the control logic 972, 982. Legacy I/O devices 1015 are coupled to the chipset 990.

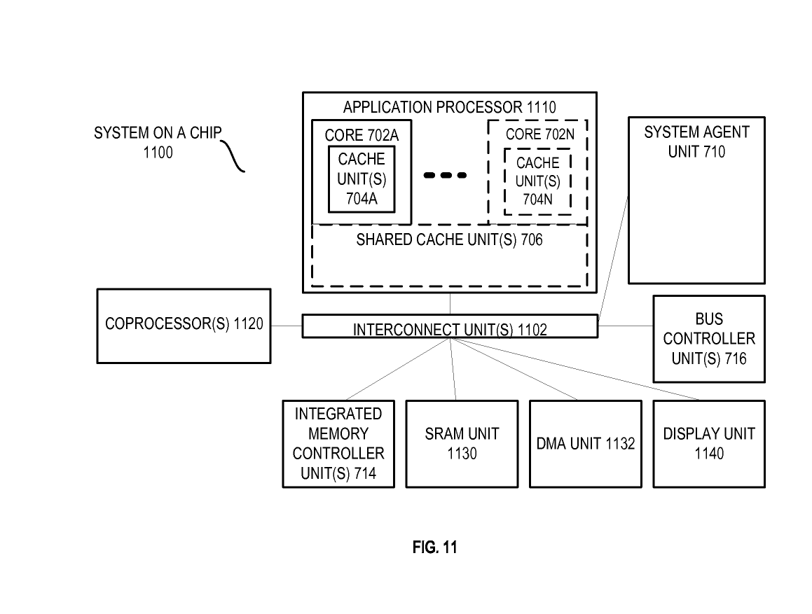

Referring now to FIG. 11, shown is a block diagram of a SoC 1100 in accordance with an embodiment of the present disclosure. Similar elements in FIG. 7 bear like reference numerals. Also, dashed lined boxes are optional features on more advanced SoCs. In FIG. 11, an interconnect unit(s) 1102 is coupled to: an application processor 1110 which includes a set of one or more cores 202A-N and shared cache unit(s) 706; a system agent unit 710; a bus controller unit(s) 716; an integrated memory controller unit(s) 714; a set or one or more coprocessors 1120 which may include integrated graphics logic, an image processor, an audio processor, and a video processor; an static random access memory (SRAM) unit 1130; a direct memory access (DMA) unit 1132; and a display unit 1140 for coupling to one or more external displays. In one embodiment, the coprocessor(s) 1120 include a special-purpose processor, such as, for example, a network or communication processor, compression engine, GPGPU, a high-throughput MIC processor, embedded processor, or the like.

Embodiments (e.g., of the mechanisms) disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code, such as code 930 illustrated in FIG. 9, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the disclosure also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

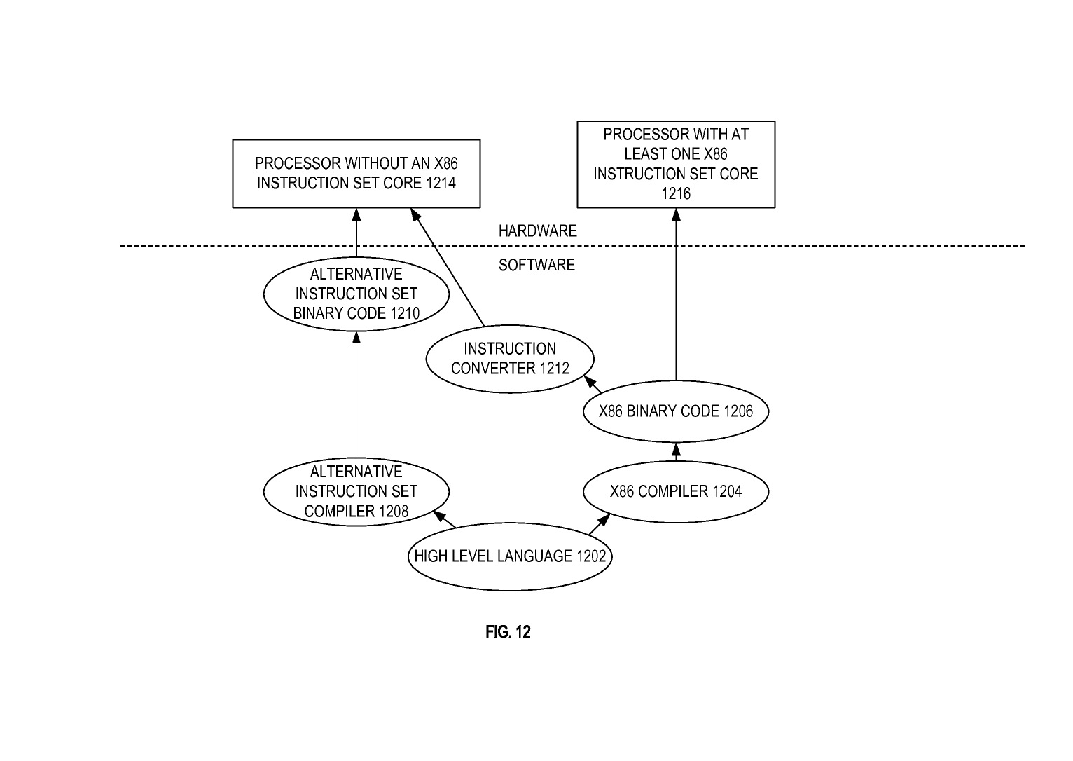

FIG. 12 is a block diagram contrasting the use of a software instruction converter to convert binary instructions in a source instruction set to binary instructions in a target instruction set according to embodiments of the disclosure. In the illustrated embodiment, the instruction converter is a software instruction converter, although alternatively the instruction converter may be implemented in software, firmware, hardware, or various combinations thereof. FIG. 12 shows a program in a high level language 1202 may be compiled using an x86 compiler 1204 to generate x86 binary code 1206 that may be natively executed by a processor with at least one x86 instruction set core 1216. The processor with at least one x86 instruction set core 1216 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1204 represents a compiler that is operable to generate x86 binary code 1206 (e.g., object code) that can, with or without additional linkage processing, be executed on the processor with at least one x86 instruction set core 1216. Similarly, FIG. 12 shows the program in the high level language 1202 may be compiled using an alternative instruction set compiler 1208 to generate alternative instruction set binary code 1210 that may be natively executed by a processor without at least one x86 instruction set core 1214 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1212 is used to convert the x86 binary code 1206 into code that may be natively executed by the processor without an x86 instruction set core 1214. This converted code is not likely to be the same as the alternative instruction set binary code 1210 because an instruction converter capable of this is difficult to make; however, the converted code will accomplish the general operation and be made up of instructions from the alternative instruction set. Thus, the instruction converter 1212 represents software, firmware, hardware, or a combination thereof that, through emulation, simulation or any other process, allows a processor or other electronic device that does not have an x86 instruction set processor or core to execute the x86 binary code 1206.

What is claimed is:

1. A hardware processor comprising:
a plurality of cores; and
a diagnostic hardware unit to isolate a core of the plurality of cores at run-time, perform a stress test on an isolated core, determine a stress factor from a result of the stress test, and store the stress factor in a data storage device.

2. The hardware processor of claim 1, wherein the result of the stress test is run-time telemetry data of the core over multiple processor cycles.

3. The hardware processor of claim 2, wherein the diagnostic hardware unit is to collect the run-time telemetry data and encrypt the run-time telemetry data before storing in the data storage device.

4. The hardware processor of claim 1, wherein the diagnostic hardware unit is to electrically swap a spare core of the plurality of cores with the isolated core.

5. The hardware processor of claim 1, wherein the diagnostic hardware unit is to encrypt the stress factor before storing in the data storage device.

6. The hardware processor of claim 1, wherein the diagnostic hardware unit is to generate a warning of a potential failure of the core based on the stress factor.

7. The hardware processor of claim 1, wherein the diagnostic hardware unit is to generate a suggested use of components of the core to reduce the stress factor.

8. The hardware processor of claim 1, wherein the diagnostic hardware unit is to disable at least one component of the core to reduce the stress factor.

9. A method comprising:
isolating a core of a plurality of cores of a hardware processor at run-time with a diagnostic hardware unit;
performing a stress test on an isolated core;
determining a stress factor from a result of the stress test; and
storing the stress factor in a data storage device.

10. The method of claim 9, wherein the result of the stress test is run-time telemetry data of the core over multiple processor cycles.

11. The method of claim 10, further comprising collecting the run-time telemetry data and encrypting the run-time telemetry data before storing in the data storage device.

12. The method of claim 9, wherein the isolating comprises electrically swapping a spare core of the plurality of cores with the isolated core.

13. The method of claim 9, further comprising encrypting the stress factor before the storing in the data storage device.

14. The method of claim 9, further comprising generating a warning of a potential failure of the core based on the stress factor.

15. The method of claim 9, further comprising generating a suggested use of components of the core to reduce the stress factor.

16. The method of claim 9, further comprising disabling at least one component of the core to reduce the stress factor.

17. A non-transitory machine readable storage medium having stored program code that when processed by a machine causes a method to be performed, the method comprising:
isolating a core of a plurality of cores of a hardware processor at run-time with a diagnostic hardware unit;
performing a stress test on an isolated core;
determining a stress factor from a result of the stress test; and
storing the stress factor in a data storage device.

18. The non-transitory machine readable storage medium of claim 17, wherein the result of the stress test is run-time telemetry data of the core over multiple processor cycles.

19. The non-transitory machine readable storage medium of claim 18, wherein the method further comprises collecting the run-time telemetry data and encrypting the run-time telemetry data before storing in the data storage device.

20. The non-transitory machine readable storage medium of claim 17, wherein the isolating comprises electrically swapping a spare core of the plurality of cores with the isolated core.

21. The non-transitory machine readable storage medium of claim 17, wherein the method further comprises encrypting the stress factor before the storing in the data storage device.

22. The non-transitory machine readable storage medium of claim 17, wherein the method further comprises generating a warning of a potential failure of the core based on the stress factor.

23. The non-transitory machine readable storage medium of claim 17, wherein the method further comprises generating a suggested use of components of the core to reduce the stress factor.

24. The non-transitory machine readable storage medium of claim 17, wherein the method further comprises disabling at least one component of the core to reduce the stress factor.
